(19) United States
(12) Patent Application Publication
(10) Pub. No.: US 2026/0065254 A1
(43) Pub. Date: Mar. 5, 2026

(54) STORE MONITORING SYSTEM, STORE MONITORING APPARATUS, AND STORAGE MEDIUM

(71) Applicant: Toshiba Tec Kabushiki Kaisha, Tokyo (JP)

(72) Inventor: Yuichiro KAWABE, Mishima Shizuoka (JP)

(21) Appl. No.: 19/212,529

(22) Filed: May 19, 2025

(30) Foreign Application Priority Data
Sep. 3, 2024 (JP) 2024-151131

(51) Int. Cl. G06Q 20/20

(52) U.S. Cl. CPC G06Q 20/208

(57) ABSTRACT

A store monitoring system includes a tag reader disposed in or near a shelf on which items with wireless tags are displayed, a point-of-sale terminal configured to acquire tag information from wireless tags attached to items and perform checkout processing on the items using the acquired tag information, and a store monitoring apparatus configured to acquire tag information from the tag reader, upon determining that first tag information previously received by the tag reader at a particular time has not been received by the tag reader for a predetermined time period since the particular time, store the first tag information in a memory, acquire tag information from the POS terminal, and upon determining that the first tag information is not in the tag information acquired by the tag reader within the predetermined time period, output an alert indicating an item associated with the first tag information.

### CROSS-REFERENCE TO RELATED APPLICATION

This application is based upon and claims the benefit of priority from Japanese Patent Application No. 2024-151131, filed Sep. 3, 2024, the entire contents of which are incorporated herein by reference.

### FIELD

Embodiments described herein relate generally to a store monitoring system, a store monitoring apparatus, and a storage medium.

### BACKGROUND

In recent years, stores such as supermarkets, mass retailers, clothing stores, and convenience stores have been introduced systems using radio frequency identification (RFID) tags (hereafter referred to as “wireless tags”) that are attachable to commodities and point of sales (POS) terminals in the store acquire tag information from the wireless tags on commodities being purchased by customers and then perform a payment process based on the acquired tag information.

Such POS terminals may distinguish between paid and unpaid commodities by writing payment information indicating payment completion into wireless tags on paid commodities to prevent theft of unpaid commodities by checking, at a gate installed at an exit, whether there is any wireless tag without payment information.

However, such anti-theft systems require installation and maintenance costs. Additionally, when actions such as removing a wireless tag from a commodity before payment are performed, it may be difficult to identify unpaid commodities at the gate, and it takes time to notice theft of commodities.

### BRIEF DESCRIPTION OF THE DRAWINGS

FIG. 1 is a diagram showing a store system.

FIG. 2 is a hardware block diagram of a tag reader.

FIG. 3 is a hardware block diagram of a server.

FIG. 4 is a data structure of tag management area.

FIG. 5 is a data structure of previous information.

FIG. 6 is a data structure of current information.

FIG. 7 is a hardware block diagram of a POS terminal.

FIG. 8 is a sequence diagram showing processing performed by the tag reader, the server, and the POS terminal and transmission and reception of information between the devices in time series.

FIG. 9 is a flowchart of control processing performed by the tag reader.

FIG. 10 is a functional block diagram of the server.

FIG. 11 is a flowchart of control processing performed by the server.

FIG. 12 is a flowchart of control processing performed by the POS terminal.

### DETAILED DESCRIPTION

Provided are a store monitoring system, a store monitoring apparatus, and a storage medium capable of reporting early if a commodity is likely being stolen.

In general, according to one embodiment, a store monitoring system comprises a tag reader disposed in or near a shelf on which items with wireless tags are displayed, the tag reader being configured to periodically transmit signals to the wireless tags and receive tag information stored in each of the wireless tags, respectively; a POS terminal configured to acquire tag information from wireless tags attached to items and perform checkout processing on the items using the acquired tag information; and a store monitoring apparatus including: a memory that stores a program, and a processor configured to execute the program to: acquire tag information from the tag reader, upon determining that first tag information previously received by the tag reader at a particular time has not been received by the tag reader for a predetermined time period since the particular time, store the first tag information in the memory, acquire tag information from the POS terminal, and upon determining that the first tag information is not in the tag information acquired by the tag reader within the predetermined time period, output an alert indicating an item associated with the first tag information.

Hereinafter, embodiments will be described with reference to the drawings. In the embodiments described below, a POS terminal will be described as an example of a sales data processing device. Note that the disclosure is not limited to the embodiments described below.

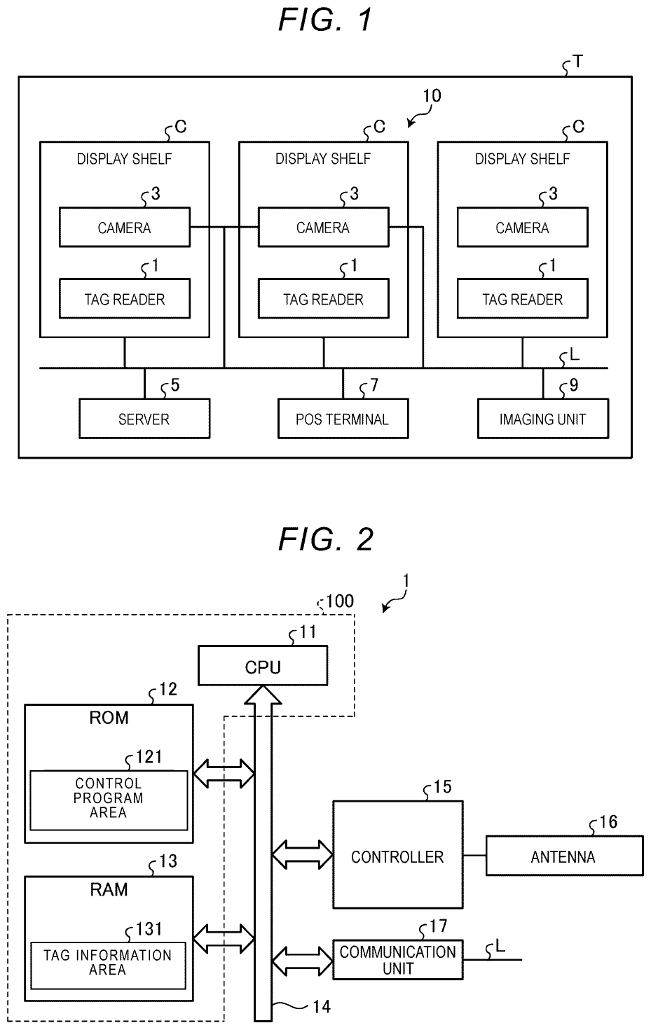

FIG. 1 is a diagram showing a store monitoring system 10 according to an embodiment introduced in a store T such as a supermarket, a mass retailer, a clothing store, or a convenience store. As shown in FIG. 1, one or a plurality of display shelves C are installed in the store T. The display shelves C are installed in a sales area for commodities and display or store commodities. For example, if the commodities are clothing, the display shelves C are shelves that display the commodities by stacking or hanging the commodities. If the commodities are food, the display shelves C are shelves or commercial cases for lining up or storing the commodities. Hereinafter, display and storage will be collectively referred to as display. A customer takes out a commodity to purchase among the commodities displayed on the display shelves C.

A wireless tag is attached (may also be referred to as “affixed”) to each of the commodities displayed on the display shelves C. Each wireless tag stores an individual item code (hereinafter also referred to as individual item information) for uniquely specifying the commodity to which the tag is attached (that is, specifies individual commodities of the same type). Hereinafter, each uniquely specified commodity (a commodity uniquely specified by an individual item code) will be referred to as an individual item. Note that the individual item code includes a commodity code that specifies the type of commodity. That is, an individual item code specifies a commodity as well as an individual item.

The system 10 is installed in the store T. The system 10 includes a tag reader 1, a camera 3, a server 5, a POS terminal 7, and an imaging unit 9. The tag reader 1, the camera 3, the server 5, the POS terminal 7, and the imaging unit 9 are connected to each other via a network (for example, a local area network (LAN)) L so that those devices can communicate (transmit and receive information) between each other.

The tag reader 1 is attached inside or near each of the installed display shelves C. The tag reader 1 receives tag information (or “reads tag information”) from wireless tags attached to commodities displayed on the display shelves C. Specifically, the tag reader 1 includes an antenna 16 (see FIG. 2) and transmits carrier waves from the antenna 16 into the display shelves C. When each wireless tag attached to a plurality of commodities displayed on the display shelves C receives the carrier waves, the wireless tag transmits, through response waves, tag information including an individual item code stored in the wireless tag of a commodity. The tag reader 1 receives the tag information transmitted from each wireless tag by the antenna 16.

The tag reader 1 repeatedly transmits carrier waves at short, predetermined time intervals (for example, every 0.5 seconds). Each wireless tag that received the carrier waves transmits tag information as response waves every time the wireless tag receives the carrier waves. The tag reader 1 receives the tag information transmitted from each wireless tag. The tag reader 1 transmits all pieces of received tag information to the server 5 every time the tag reader 1 receives tag information (for example, every 0.5 seconds). Therefore, if a certain commodity is taken out from the display shelf C, tag information from the commodity that was included in the tag information received before the commodity was taken out is not included in the tag information received after the commodity is taken out. Accordingly, a difference occurs in the tag information transmitted to the server 5.

In one embodiment, one tag reader 1 is provided for each display shelf C, but the number of tag readers 1 attached to each display shelf C is freely selected. One tag reader 1 may be attached to a plurality of display shelves C.

The camera 3 is installed on each display shelf C. The camera 3 is running at all times and captures images of commodities taken out from the display shelf C and customers taking out commodities from the display shelf C. The camera 3 has a clock function and adds data indicating a time of capture to the captured image. The camera 3 transmits the captured image attached with the capture time to the server 5. In one embodiment, one camera 3 is installed on each display shelf C, but, for example, one or a plurality of cameras 3 may be attached to a ceiling of the store T, and the cameras 3 may capture images of commodities taken out from the display shelf C and customers taking out commodities for each of the display shelves C.

The server 5 is a store server installed in a back office of the store T, for example. The server 5 manages sales information of commodities sold in the store T. The server 5 is also referred to as a store monitoring apparatus.

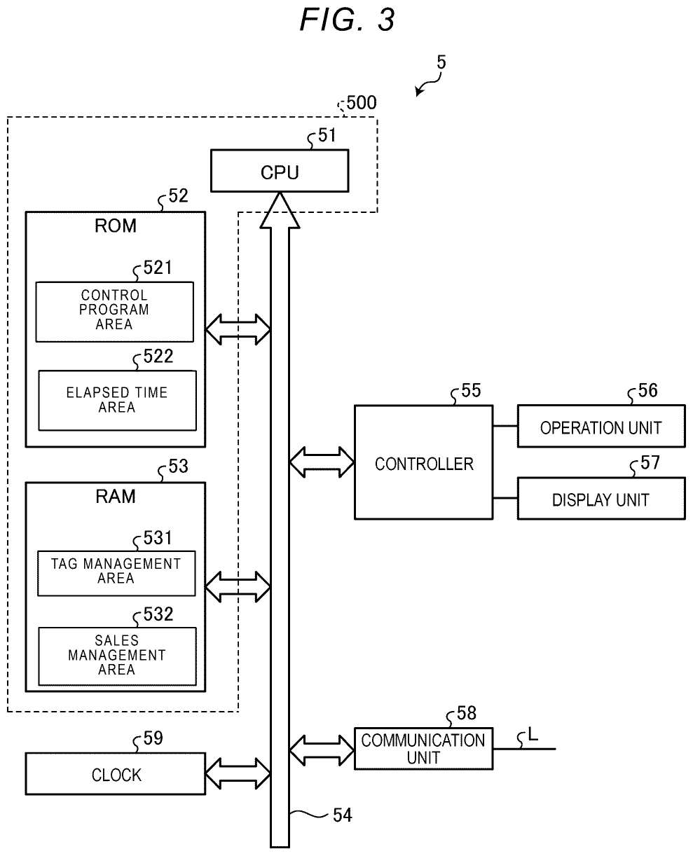

The server 5 also stores the tag information received from the tag reader 1 in tag management area 531 (see FIG. 3) for each individual item code. The tag management area 531 includes an information unit that individually stores at least two pieces of received tag information (individual item codes included in each piece of tag information). That is, the server 5 individually stores the tag information received earlier (previously) and the tag information received next (currently).

As described above, if a commodity is taken out from the display shelf C, a difference occurs between individual item codes included in tag information before the commodity is taken out and individual item codes included in tag information after the commodity is taken out, and thus a difference also occurs between individual item codes included in the tag information received by the server 5 before the commodity is taken out and individual item codes included in the tag information received by the server 5 after the commodity is taken out. Accordingly, the server 5 can compare both pieces of tag information and obtain the difference in individual item codes to grasp that an individual item is taken out from the display shelf C (that is, grasp an individual item taken out from the display shelf C), the individual item being specified by an individual item code included in the tag information received before the commodity was taken out and not included in the tag information received after the commodity was taken out.

The server 5 also attaches a time of reception (specifically, a time stored in time data 53121 of current information 5312) to individual item codes related to each piece of tag information received from the tag reader 1 as difference information. If a commodity is taken out between two pieces of tag information received sequentially, in the embodiment, the tag reader 1 transmits tag information at short predetermined time intervals (for example, every 0.5 seconds) and the server 5 receives the tag information transmitted by the same predetermined time intervals, and thus a time when the server 5 receives the tag information substantially corresponds to a time when the commodity was taken out.

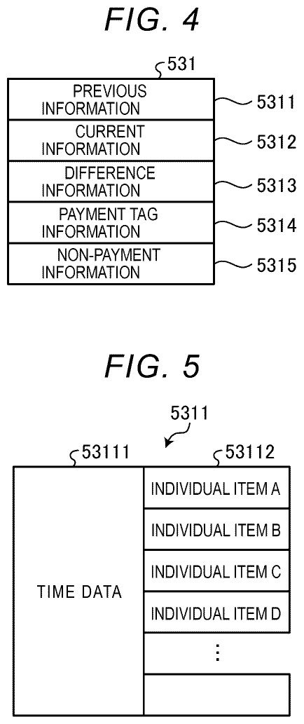

The server 5 also stores the individual item code of the taken-out individual item in the tag management area 531 (difference information 5313, see FIGS. 3 and 4) together with the assigned time (that is, the time when the tag information of the individual item is received, that is, the time when the individual item is taken out from the display shelf C).

One or a plurality of POS terminals 7 are installed in a checkout area of the store T. A customer brings a commodity taken out from the display shelf C and pays using the POS terminal 7. A payment operation using the POS terminal 7 is performed by a staff member of the store T or customers themselves.

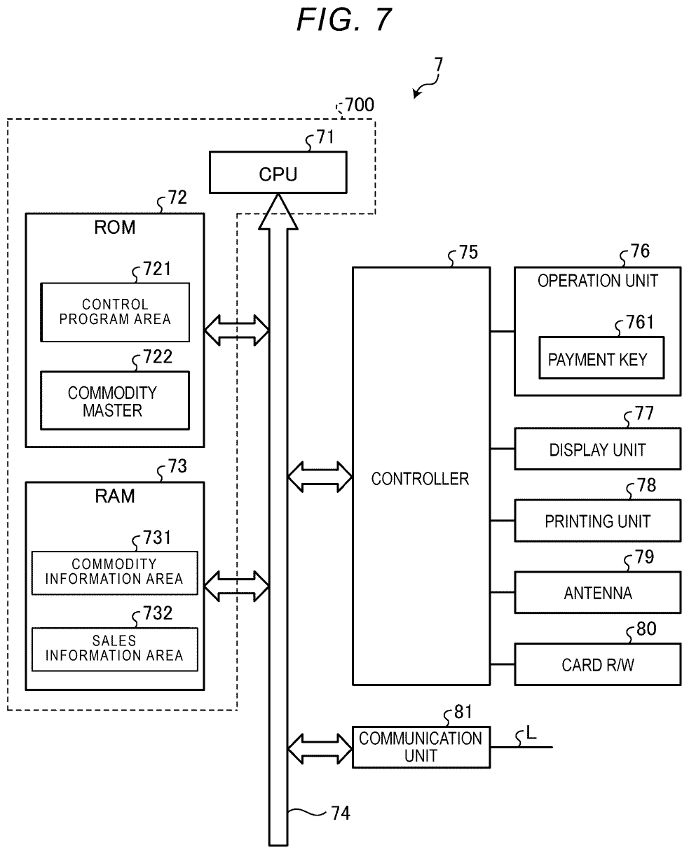

The POS terminal 7 executes a commodity registration process and a payment process for the commodity brought by the customer. The commodity registration process is a process of acquiring an individual item code by an antenna 79 (see FIG. 7) that receives tag information transmitted from a wireless tag attached to each commodity, importing commodity information (e.g., the name, price, and the like of the commodity) of the commodity specified by the commodity code included in the individual item code from a commodity master 722, displaying the imported commodity information on a display unit 77, and storing the commodity information (including the acquired individual item code) in a commodity information area 731 (see FIG. 7). The payment process is a process of performing a settlement process for the commodity based on the commodity information stored in the commodity information area 731 and dispensing a receipt on which commodity information and settlement information (e.g., the total amount, deposit, change, and the like) related to the settled commodity are printed.

The POS terminal 7 also transmits sales information (including commodity information including an individual item code and settlement information) of the paid commodity to the server 5.

The server 5 stores the sales information received from the POS terminal 7 in a sales management area 532 (see FIG. 3). The server 5 stores the individual item code included in the sales information stored in the sales management area 532 also in payment tag information 5314. That is, an individual item with an individual item code stored in the difference information 5313 but not stored in the payment tag information 5314 is an unpaid commodity.

For example, if the store T is a store where shopping takes about one hour on average, the one hour or a time slightly longer than one hour is set as a predetermined time (hereinafter referred to as “elapsed time”), and the server 5 determines that an individual item with an individual item code stored in the difference information 5313 but still not stored in the payment tag information 5314 after the elapsed time elapsed is an individual item that is likely being stolen (hereinafter also referred to as an unpaid individual item). Specifically, for individual items stored in the difference information 5313, the server 5 determines that an individual item not stored in the payment tag information 5314 even after the elapsed time elapsed from the time assigned to each individual item code is an individual item that is likely being stolen (an unpaid individual item).

The server 5 stores a captured image transmitted from the camera 3 and attached with the time of capture in the imaging unit 9, which functions as a data storage apparatus for storing the images captured by the camera 3. Therefore, it is possible to designate a desired time and confirm captured images before and after the time. For an individual item determined as an unpaid individual item, it is possible to confirm captured images before and after the time attached to the individual item code of the individual item. Then, it is possible to confirm a customer who took out the commodity at the time based on the captured images. The server 5 may read the captured images before and after the time attached to the individual item code of the individual item determined to be an unpaid individual item from the imaging unit 9 and store the capture images together with the individual item code of the unpaid individual item.

Hereinafter, a hardware configuration of the tag reader 1 will be described. FIG. 2 is a hardware block diagram of the tag reader 1. As shown in FIG. 2, the tag reader 1 includes a central processing unit (CPU) 11 as an example of a processor, a read only memory (ROM) 12, a random access memory (RAM) 13, and the like. The CPU 11 is a main controller of the tag reader 1. The ROM 12 stores an operating system (OS) and various programs. Note that a hard disc drive (HDD) or a solid state drive (SSD) may be used instead of or in addition to the ROM 12. The RAM 13 is a memory in which programs and various types of data are loaded. The CPU 11, the ROM 12, and the RAM 13 are connected to each other via a bus 14. The CPU 11, the ROM 12, and the RAM 13 make up a control unit 100. That is, the control unit 100 executes a control process of the tag reader 1 described later by causing the CPU 11 to operate according to a control program stored in the ROM 12 and loaded in the RAM 13.

The ROM 12 includes a control program area 121 that stores the control program for operating the tag reader 1.

The RAM 13 includes a tag information area 131. The tag information area 131 stores tag information transmitted by each wireless tag attached to the commodities displayed on the display shelf C and received by the antenna 16 in response to carrier waves transmitted from the antenna 16.

The control unit 100 is also connected to the antenna 16 via the bus 14 and a controller 15. The antenna 16 repeatedly transmits carrier waves toward the plurality of commodities displayed on the display shelf C at predetermined time intervals. The antenna 16 also receives tag information including an individual item code and transmitted from the wireless tag that received the transmitted carrier waves.

The control unit 100 is also connected to a communication unit 17 having a communication interface function via the bus 14. The communication unit 17 is an interface circuit connected to the server 5 and the POS terminal 7 via the network L so that information can be transmitted and received.

Next, a hardware configuration of the server 5 will be described. FIG. 3 is a hardware block diagram of the server 5. As shown in FIG. 3, the server 5 includes a CPU 51 as an example of a processor, a ROM 52, a RAM 53, and the like. The CPU 51 is a main controller of the server 5. The ROM 52 stores an OS and various programs. Note that an HDD or an SSD may be used instead of or in addition to the ROM 52. The RAM 53 is a memory in which programs and various types of data are loaded. The CPU 51, the ROM 52, and the RAM 53 are connected to each other via a bus 54. The CPU 51, the ROM 52, and the RAM 53 make up a control unit 500. That is, the control unit 500 executes a control process of the server 5 described later by causing the CPU 51 to operate according to a control program stored in the ROM 52 and loaded in the RAM 53.

The ROM 52 includes a control program area 521 and an elapsed time area 522. The control program area 521 stores the control program to be executed by the server 5. The elapsed time area 522 stores elapsed time (hereinafter also referred to as a predetermined time). The elapsed time stored in the elapsed time area 522 can be set or changed freely according to a size and a management form of the store T.

The RAM 53 includes the tag management area 531 and the sales management area 532. The tag management area 531 manages the individual item codes included in the tag information received from the tag reader 1 and the individual item codes included in the sales information received from the POS terminal 7. The tag management area 531 will be described later with reference to FIGS. 4 to 6. The sales management area 532 cumulatively stores the sales information received from the POS terminal 7.

The control unit 500 is also connected to an operation unit 56 and a display unit 57 via a bus 54 and a controller 55. The operation unit 56 is, for example, a keyboard or a touch panel, and is operated by an operator of the server 5. The display unit 57 is, for example, a liquid crystal display, and displays information to the operator who operates the server 5.

The control unit 500 is also connected to a communication unit 58 having a communication interface function via the bus 54. The communication unit 58 is an interface circuit connected to the tag reader 1, the POS terminal 7, and the imaging unit 9 via the network L so that information can be transmitted and received.

The control unit 500 is also connected to a real-time clock 59 via the bus 54. The clock 59 tracks time at all times to track a time when tag information is received from the tag reader 1.

Next, the tag management area 531 will be described. FIG. 4 is a data structure of the tag management area 531. The tag management area 531 stores previous information 5311, current information 5312, difference information 5313, payment tag information 5314, and non-payment information 5315.

The previous information 5311 stores tag information received previously (e.g., 0.5 seconds before current time) among pieces of tag information received from the tag reader 1 at predetermined time intervals. FIG. 5 is a data structure of the previous information 5311. The previous information 5311 includes time data 53111 and individual item information 53112. The time data 53111 stores a time when the server 5 received previous tag information from the tag reader 1. The individual item information 53112 individually stores individual item codes included in the tag information received previously by the server 5 from the tag reader 1. In the example of FIG. 5, the individual item codes included in the tag information received previously and including individual item codes of individual items A, B, C, and D are stored.

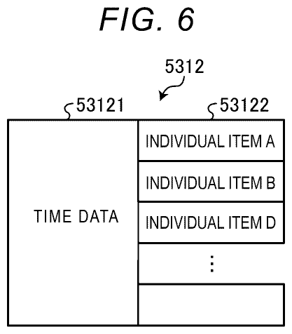

The current information 5312 stores tag information received currently (e.g., 0.5 seconds after previous time) among pieces of tag information received from the tag reader 1 at predetermined time intervals. FIG. 6 is a data structure of the current information 5312. The current information 5312 includes time data 53121 and individual item information 53122. The time data 53121 stores a time when the server 5 received tag information from the tag reader 1 currently. The individual item information 53122 individually stores individual item codes included in the tag information received currently by the server 5 from the tag reader 1. In the example of FIG. 6, the individual item codes included in the tag information received currently and including individual item codes of individual items A, B, and D are stored.

The difference information 5313 stores individual item codes extracted as a difference between the individual item codes stored in the individual item information 53112 of the previous information 5311 and the individual item codes stored in the individual item information 53122 of the current information 5312. Specifically, the difference information 5313 individually stores the individual item codes stored in the individual item information 53112 but not stored in the individual item information 53122. For example, the individual item information 53112 in FIG. 5 stores individual item codes included in the tag information received previously and including the individual item codes of the individual items A, B, C, and D, while the individual item information 53122 stores individual item codes included in the tag information received currently and including the individual item codes of the individual items A, B, and D. Comparing the two individual item information units 53112 and 53122, the individual item information 53112 stores the individual item code of the individual item C, but the individual item information 53122 does not store the individual item code of the individual item C. By taking the difference between the two individual item information units 53112 and 53122, it is possible to grasp that the individual item code of individual item C is not stored in the individual item information 53122. The difference information 5313 compares the individual item codes stored in the individual item information 53112 with the individual item codes stored in the individual item information 53122 and stores different individual item codes (e.g., the individual item code of the individual item C in the above example) between the two individual item codes. When individual item codes of a plurality of individual items are extracted as a result of taking the difference, the difference information 5313 stores each individual item code. The individual item specified by the individual item code stored in the difference information 5313 is an individual item taken out from the display shelf C. The time when each individual item was taken out from the display shelf C stored in the time data 53121 (the time stored in the time data 53121 when tag information of the individual item was received by the server 5) is attached to the individual item code stored in the difference information 5313.

When the difference information (information in which the time is attached to the individual item code) is stored in the difference information 5313, all pieces of information stored in the previous information 5311 is erased, all pieces of information stored in the current information 5312 is moved to the previous information 5311, and the information stored in the current information 5312 is erased. Then, after 0.5 seconds, each piece of information related to the tag information received next is stored in the current information 5312 and similarly compared, and the difference information is stored in the difference information 5313. The server 5 repeats the processing.

The payment tag information 5314 stores an individual item code of an individual item paid for in the POS terminal 7. Specifically, the payment tag information 5314 stores an individual item code included in sales information related to the individual item paid for in the POS terminal 7.

The non-payment information 5315 stores an individual item code of an individual item taken out from the display shelf C and not paid for even after a predetermined time elapsed. Specifically, the non-payment information 5315 stores, among the individual item codes stored in the difference information 5313, individual item codes not stored in the payment tag information 5314 and for which a predetermined time elapsed. That is, individual items with individual item codes stored in the non-payment information 5315 are commodities not paid for even after a predetermined time elapsed since the commodities were taken out from the display shelf C, and the server 5 determines that the commodities are likely being stolen.

Next, a hardware configuration of the POS terminal 7 will be described. FIG. 7 is a hardware block diagram of the POS terminal 7. As shown in FIG. 7, the POS terminal 7 includes a CPU 71 as an example of a processor, a ROM 72, and a RAM 73. The CPU 71 is a main controller of the POS terminal 7. The ROM 72 stores an OS and various programs. Note that an HDD or an SSD may be used instead of or in addition to the ROM 72. The RAM 73 is a memory in which programs and various types of data are loaded. The CPU 71, the ROM 72, and the RAM 73 are connected to each other via a bus 74. The CPU 71, the ROM 72, and the RAM 73 make up a control unit 700. That is, the control unit 700 executes a control process of the POS terminal 7 described later by causing the CPU 71 to operate according to a control program stored in the ROM 72 and loaded in the RAM 73.

The ROM 72 includes a control program area 721 and a commodity master 722. The control program area 721 stores the control program to be executed by the POS terminal 7. For all commodities sold at the store T, the commodity master 722 stores commodity information (e.g., the commodity name, commodity price, and the like) of the commodities for each commodity code as commodity specification information for specifying a commodity.

The RAM 73 includes a commodity information area 731 and a sales information area 732. The commodity information area 731 stores commodity information (including individual item codes) of registered commodities. The sales information area 732 stores sales information (including commodity information, settlement information, and individual item codes) of commodities paid for in one transaction.

The control unit 700 is also connected to an operation unit 76, a display unit 77, a printing unit 78, an antenna 79, and a card R/W (reader and writer) 80 via a bus 74 and a controller 75. The operation unit 76 is, for example, a keyboard or a touch panel provided together with the display unit 77, and is operated by an operator of the POS terminal 7. The operation unit 76 includes a payment key 761. The payment key 761 is operated when a commodity registration process for a commodity to be purchased ends and transitions to payment. The display unit 77 is, for example, a liquid crystal display, and displays information to the operator who operates the POS terminal 7. The printing unit 78 is, for example, a thermal printer, and dispenses a receipt on which commodity information and settlement information of the paid commodity are printed. The antenna 79 reads tag information from a wireless tag attached to the purchased commodity. The control unit 700 registers a commodity based on an individual item code (a commodity code included in the individual item code) included in the tag information read by the antenna 79. The card R/W 80 reads information from, for example, a membership card held by a customer. The card R/W 80 also reads information from a medium used for payment by the customer (for example, a credit card or a debit card). The card R/W 80 also reads points from the medium and writes points generated along the payment process to the medium.

The control unit 700 is also connected to a communication unit 81 having a communication interface function via the bus 74. The communication unit 81 is an interface circuit connected to the tag reader 1, the server 5, and the imaging unit 9 via the network L so that information can be transmitted and received.

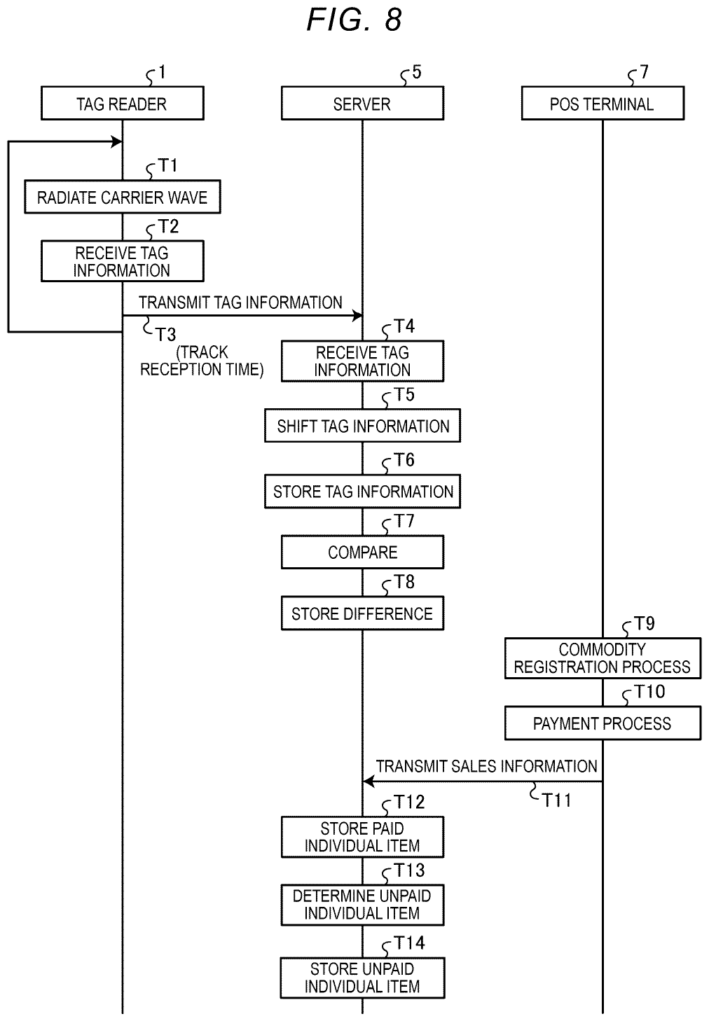

Hereinafter, the processes executed by the tag reader 1, the server 5, and the POS terminal 7 and transmission and reception of information between those devices will be described. FIG. 8 is a sequence diagram showing the processes performed by the tag reader 1, the server 5, and the POS terminal 7 and the transmission and reception of information in time series. As shown in FIG. 8, the tag reader 1 transmits carrier waves from the antenna 16 to the wireless tags each attached to each of a plurality of commodities displayed on the display shelf C (T1). The tag reader 1 receives tag information included in response waves from each wireless tag and stores the tag information in the tag information area 131 (T2). The tag reader 1 transmits the stored tag information to the server 5 (T3). The tag reader 1 repeatedly performs the processes of T1 to T3 at predetermined time intervals (for example, every 0.5 seconds).

The server 5 receives tag information transmitted from the tag reader 1 each time (for example, every 0.5 seconds) (T4). The server 5 erases the information stored in the previous information 5311 and moves the information stored in the current information 5312 to the previous information 5311 (T5). The server 5 then stores the received tag information in the current information 5312 together with the time of reception (T6).

Next, the server 5 compares the tag information (the individual item code) stored in the previous information 5311 with the tag information (the individual item code) stored in the current information 5312 (T7). The server 5 stores the individual item code extracted as a difference (an individual item code stored in the previous information 5311 and not stored in the current information 5312) in the difference information 5313 together with the time stored in the current information 5312 (T8).

The POS terminal 7 registers a commodity purchased by a customer (T9). The POS terminal 7 executes a payment process for the registered commodity (T10). The POS terminal 7 transmits sales information (including individual item codes) related to the paid commodity to the server 5 (T11).

The server 5 stores the individual item codes included in the sales information received from the POS terminal 7 in the payment tag information 5314 (T12). Then, the server 5 determines whether there is an individual item code stored in the difference information 5313 but not stored in the payment tag information 5314 and for which a predetermined time elapsed (an unpaid individual item) (T13). That is, the server 5 determines whether there is an individual item that is likely being stolen (T13). If the server 5 determines that there is an unpaid individual item, the server 5 stores the individual item code (including the individual item code and the assigned time of the unpaid individual item) in the non-payment information 5315 (T14).

The server 5 displays the individual item with the individual item code stored in the non-payment information 5315, or transmits information thereof to a mobile terminal of a store clerk or the like as a report or alert of potential theft. The server 5 may search the imaging unit 9 based on the time when the individual item with the individual item code stored in the non-payment information 5315 was taken out, cut out a captured image near the time, and store the captured image in the non-payment information 5315 together with the individual item code stored in the non-payment information 5315.

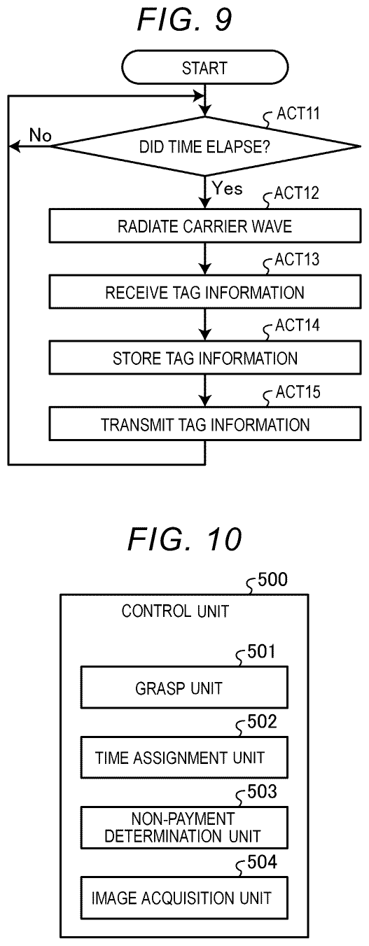

Hereinafter, control of the tag reader 1 will be described. FIG. 9 is a flowchart of processing performed by the tag reader 1. As shown in FIG. 9, the control unit 100 of the tag reader 1 determines whether a predetermined time interval measured by a timer (not shown) for transmitting carrier waves from the antenna 16 elapsed (that is, whether 0.5 seconds elapsed) (ACT11). The control unit 100 waits until the time elapses (No in ACT11), and if it is determined that the time elapsed (Yes in ACT11), the control unit 100 transmits carrier waves toward a wireless tag attached to a commodity displayed on the display shelf C (ACT12). The control unit 100 receives tag information (including an individual item code) included in response waves transmitted from the wireless tag that received the carrier waves (ACT13). The control unit 100 stores the received tag information in the tag information unit 131 (ACT14). The control unit 100 transmits the tag information stored in the tag information unit 131 to the server 5 (ACT15). The control unit 100 returns to ACT11.

Hereinafter, a functional configuration of the server 5 will be described. FIG. 10 is a functional block diagram showing the functional configuration of the server 5. The control unit 500 of the server 5 functions as a grasp unit 501, a time assignment unit 502, a non-payment determination unit 503, and an image acquisition unit 504 by executing the control program stored in the control program area 521 of the ROM 52.

The grasp unit 501 receives tag information including an individual item code for uniquely specifying a commodity from the wireless tag attached to the commodity, and grasps or determines an individual item taken out from the display shelf C on which commodities are displayed. Specifically, the grasp unit 501 compares the previous tag information with the current tag information received from the tag reader 1, and grasps an individual item code included in the previous tag information but not included in the current tag information. More specifically, the grasp unit 501 compares the individual item code stored in the previous information 5311 with the individual item code stored in the current information 5312, and grasps an individual item code stored in the previous information 5311 but not stored in the current information 5312.

The time assignment unit 502 assigns a time when the individual item with the individual item code grasped by the grasp unit 501 was taken out from the display shelf C to the individual item code and stores the time. More specifically, the time assignment unit 502 assigns the time when the individual item code was received from the tag reader 1 to the individual item code grasped by the grasp unit 501 and stores the time. More specifically, the time assignment unit 502 assigns the time stored in the time data 53121 to the individual item code grasped by the grasp unit 501 and stores the time.

The non-payment determination unit 503 determines that an individual item for which a predetermined time or more elapsed since the assigned time is an unpaid individual item among individual items assigned with the time by the time assignment unit 502. Specifically, the non-payment determination unit 503 determines that an individual item with an individual item code for which a predetermined time or more elapsed since the assigned time is an unpaid individual item among the individual item codes stored in the time assignment unit 502.

The image acquisition unit 504 acquires images captured near the time when the unpaid individual item was taken out among images obtained by capturing the vicinity of the display shelf C. Specifically, the image acquisition unit 504 acquires, from the imaging unit 9, images captured near the time when the individual item determined to be an unpaid individual item by the non-payment determination unit 503 was taken out.

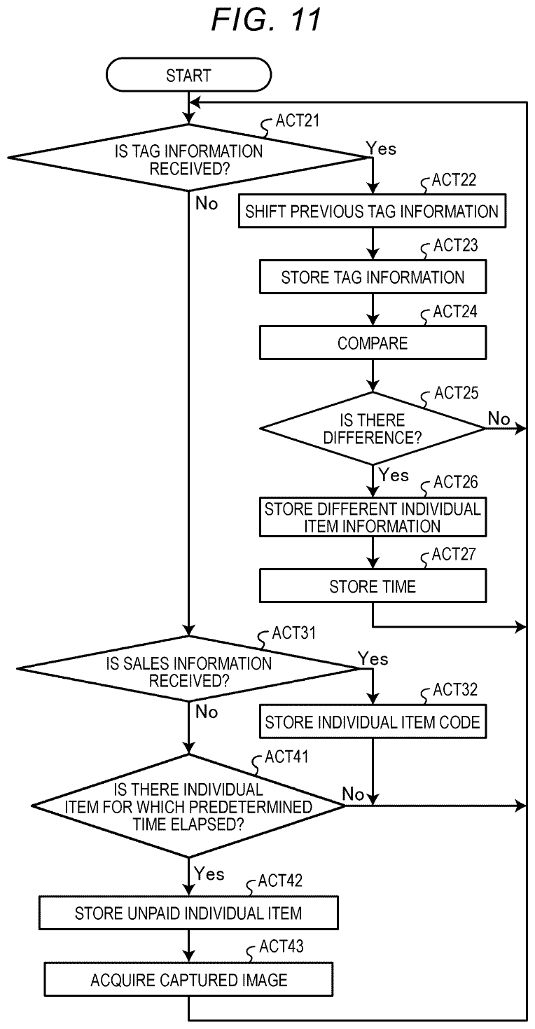

Hereinafter, control of the server 5 will be described. FIG. 11 is a flowchart of processing executed by the server 5. As shown in FIG. 11, the control unit 500 of the server 5 determines whether tag information is received from the tag reader 1 (ACT21). If it is determined that tag information is received (Yes in ACT21), the control unit 500 stores the individual item code and the time stored in the current information 5312 in the previous information 5311 (ACT22). Specifically, the control unit 500 moves the time stored in the time data 53121 to the time data 53111, and moves the individual item code stored in the individual item information 53122 to the individual item information 53112. The control unit 500 stores the individual item code included in the received tag information in the current information 5312 (ACT23). Specifically, the control unit 500 stores the individual item code included in the received tag information in the individual item information 53122, and stores the time tracked by the clock 59 when the tag information was received in the time data 53121 (ACT23).

Next, the control unit 500 compares the individual item code stored in the previous information 5311 with the individual item code stored in the current information 5312 (ACT24). Specifically, the control unit 500 compares the individual item code stored in the individual item information 53112 with the individual item code stored in the individual item information 53122 (ACT24). The control unit 500 determines whether there is a difference between the compared individual item codes (ACT25). Specifically, the control unit 500 determines whether there is an individual item code stored in the individual item information 53112 but not stored in the individual item information 53122 (ACT25). If it is determined that there is no difference (No in ACT25), the processing returns to ACT21. If it is determined that there is a difference (Yes in ACT25), the grasp unit 501 stores the individual item code extracted as the difference (that is, an individual item code stored in the individual item information 53112 but not stored in the individual item information 53122) in the difference information 5313 (ACT26). The time assignment unit 502 assigns the time stored in the time data 53121 to the individual item code stored in the difference information 5313 (ACT27). That is, the time assignment unit 502 assigns the time of takeout to the individual item taken out from the display shelf C. Then, the control unit 500 returns to ACT21.

If it is determined that the tag information is not received (No in ACT21), the control unit 500 determines whether sales information is received from the POS terminal 7 (ACT31). If it is determined that sales information is received (Yes in ACT31), an individual item code included in the sales information is stored in the payment tag information 5314 (ACT32). Then, the control unit 500 returns to ACT21.

If it is determined that sales information is not received from the POS terminal 7 (No in ACT31), the non-payment determination unit 503 determines whether there are any individual item codes not stored in the payment tag information 5314 and for which a predetermined time or more elapsed since the time assigned to each of the individual item codes of unpaid individual items among the individual item codes stored in the difference information 5313 (ACT41). If it is determined that there is no individual item code of an unpaid individual item (No in ACT41), the control unit 500 returns to ACT21. If it is determined that there is an individual item code of an unpaid individual item (Yes in ACT41), the control unit 500 stores the individual item code together with the assigned time in the non-payment information 5315 (ACT42). The image acquisition unit 504 stores images captured near the stored time (for example, before or after the time or for a certain period of time from the time) among the captured images stored in the imaging unit 9 in association with the individual item codes stored in the non-payment information 5315 (ACT43). The control unit 500 notifies a store clerk that there is a commodity that is likely being stolen by displaying on the display unit 57 and/or by transmitting information regarding possibility of theft to a mobile terminal carried by the store clerk. The control unit 500 then returns to ACT21.

According to the server 5 described above, if there is a commodity not paid for by the POS terminal 7 and for which a predetermined time elapsed since the commodity was taken out among commodities taken out from the display shelves C, it is determined that the commodity is likely being stolen, and a report to a store clerk or the like of the store T is made. Therefore, it is possible to detect and report early if a commodity is likely being stolen.

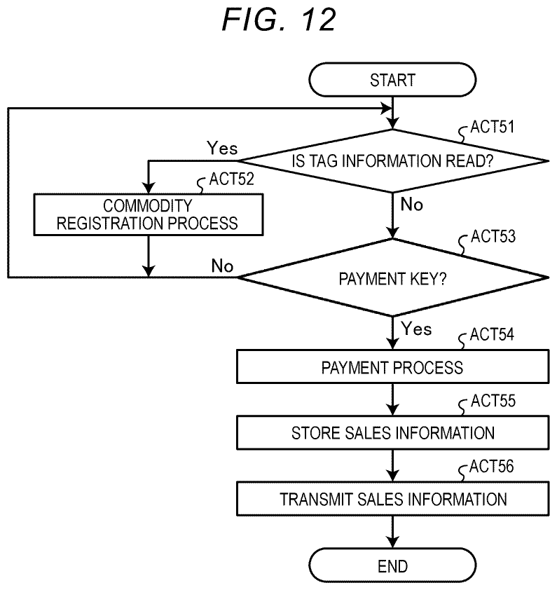

Hereinafter, control of the POS terminal 7 will now be described. FIG. 12 is a flowchart of control processing performed by the POS terminal 7. The control unit 700 of the POS terminal 7 determines whether a wireless tag is read by the antenna 79 (ACT51). If it is determined that a wireless tag is read (Yes in ACT51), the control unit 700 registers the commodity (ACT52). The control unit 700 then returns to ACT51.

If it is determined that a wireless tag is not read (No in ACT51), the control unit 700 determines whether the payment key 761 is operated (ACT53). If it is determined that the payment key 761 is not operated (No in ACT53), the control unit 700 returns to ACT51. If it is determined that the payment key 761 is operated (Yes in ACT53), the control unit 700 executes a payment process for the transaction based on the commodity information stored in the commodity information area 731 (ACT54). The control unit 700 stores sales information for the paid commodity in the sales information area 732 (ACT55). The control unit 700 transmits the sales information (including an individual item code) stored in the sales information area 732 to the server 5 (ACT56). The control unit 700 ends processing for one transaction and returns to ACT51.

As described above, the server 5 described above includes the grasp unit 501 that receives tag information including an individual item code for uniquely specifying a commodity from a wireless tag attached to the commodity and grasps an individual item taken out from the display shelf C on which commodities are displayed, the time assignment unit 502 that assigns a time when the individual item grasped by the grasp unit 501 was taken out from the display shelf C to the individual item and stores the time, and the non-payment determination unit 503 that determines an individual item not paid for in the POS terminal 7 and for which a predetermined time or more elapsed since the time assigned by the time assignment unit 502 as an unpaid individual item among individual items stored in the time assignment unit 502.

The server 5 determines an individual item not paid for in the POS terminal 7 and for which a predetermined time or more elapsed since the individual item was taken out from the display shelf C as an unpaid individual item. Therefore, it is possible to early identify that a commodity is likely being stolen.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

For example, the server 5 is described as a device separate from the POS terminal 7. However, embodiments are not limited thereto, and if the POS terminal 7 has a server function, the server of the exemplary embodiment may be the POS terminal 7.

In the above-described embodiments, the time assignment unit 502 assigns the time stored in the time data 53121 as the time when an individual item was taken out from the display shelf. However, embodiments are not limited thereto, and the time stored in the time data 53111 of the previous information 5311 may be assigned as the time when the individual item was taken out from the display shelf.

In the above-described embodiments, two information units of the previous information 5311 and the current information 5312 are provided as information units for storing tag information received from the tag reader 1. However, embodiments are not limited thereto, and the number of information units is not limited to two and may be two or more.

The program executed by the server 5 is provided by being recorded on a non-transitory computer-readable recording medium such as a CD-ROM, a flexible disk (FD), a CD-R, or a digital versatile disk (DVD) in an installable or executable format.

The program executed by the server 5 may be stored on a computer connected to the network L such as the Internet and provided by being downloaded via the network L. The program executed by the server 5 of the embodiment may be provided or distributed via the network L such as the Internet.

The program executed by the server 5 may be provided by being pre-installed in the ROM 32 or the like.

What is claimed is:

1. A store monitoring system comprising:
a tag reader disposed in or near a shelf on which items with wireless tags are displayed, the tag reader being configured to periodically transmit signals to the wireless tags and receive tag information stored in each of the wireless tags, respectively;
a point-of-sale (POS) terminal configured to acquire tag information from wireless tags attached to items and perform checkout processing on the items using the acquired tag information; and
a store monitoring apparatus including:
a memory that stores a program, and
a processor configured to execute the program to:
acquire tag information from the tag reader,
upon determining that first tag information previously received by the tag reader at a particular time has not been received by the tag reader for a predetermined time period since the particular time, store the first tag information in the memory,
acquire tag information from the POS terminal, and
upon determining that the first tag information is not in the tag information acquired by the tag reader within the predetermined time period, output an alert indicating an item associated with the first tag information.

2. The store monitoring system according to claim 1, further comprising:
a camera configured to capture images of the shelf and the items displayed on the shelf, wherein
the processor executes the program to:
acquire the images captured by the camera, and
upon determining that the first tag information has not been acquired by the tag reader within the predetermined time period, identify an image captured before and an image captured after a time point at which the first tag information was most recently received by the tag reader.

3. The store monitoring system according to claim 2, wherein
the processor executes the program to store in the memory the images captured before and after the time point association with the item corresponding to the first tag information.

4. The store monitoring system according to claim 2, further comprising:
a data storage apparatus configured to store the images captured by the camera.

5. The store monitoring system according to claim 1, further comprising:
a mobile terminal, wherein
the alert indicates that the item associated with the first tag information is likely being stolen, and
the alert is output to the mobile terminal.

6. The store monitoring system according to claim 1, wherein
the tag information in each wireless tag is a code that identifies a type of commodity and the individual item with which the wireless tag associated.

7. The store monitoring system according to claim 1, wherein
the wireless tags are radio frequency identification (RFID) tags.

8. A store monitoring apparatus comprising:
an interface circuit connectable to:
a tag reader disposed in or near a shelf on which items with wireless tags are displayed, the tag reader being configured to periodically transmit signals to the wireless tags and receive tag information stored in each of the wireless tags, respectively, and
a point-of-sale (POS) terminal configured to acquire tag information from wireless tags attached to items and perform checkout processing on the items using the acquired tag information;
a memory that stores a program; and
a processor configured to execute the program to:
acquire tag information from the tag reader,
upon determining that first tag information previously received by the tag reader at a particular time has not been received by the tag reader for a predetermined time period since the particular time, store the first tag information in the memory,
acquire tag information from the POS terminal, and
upon determining that the first tag information is not in the tag information acquired by the tag reader within the predetermined time period, output an alert indicating an item associated with the first tag information.

9. The store monitoring apparatus according to claim 8, wherein
the interface circuit is connectable to a camera configured to capture images of the shelf and the items displayed on the shelf, and
the processor executes the program to:
acquire the images captured by the camera, and
upon determining that the first tag information has not been acquired by the tag reader within the predetermined time period, identify an image captured before and an image captured after a time point at which the first tag information was most recently received by the tag reader.

10. The store monitoring apparatus according to claim 9, wherein
the processor executes the program to store in the memory the images captured before and after the time point association with the item corresponding to the first tag information.

11. The store monitoring apparatus according to claim 9, wherein
the processor executes the program to acquire the images from a data storage apparatus through the interface circuit.

12. The store monitoring apparatus according to claim 8, wherein
the processor executes the program to control the interface circuit to output the alert to a mobile terminal, and
the alert indicates that the item associated with the first tag information is likely being stolen.

13. The store monitoring apparatus according to claim 8, wherein
the tag information in each wireless tag is a code that identifies a type of commodity and the individual item with which the wireless tag associated.

14. The store monitoring apparatus according to claim 8, wherein
the wireless tags are radio frequency identification (RFID) tags.

15. A non-transitory computer readable storage medium that stores a program causing a computer to execute a method comprising:
connecting to a tag reader disposed in or near a shelf on which items with wireless tags are displayed, the tag reader being configured to periodically transmit signals to the wireless tags and receive tag information stored in each of the wireless tags, respectively;
acquiring the tag information from the tag reader, and upon determining that first tag information previously received by the tag reader at a particular time has not been received by the tag reader for a predetermined time period since the particular time, storing the first tag information in a memory;
connecting to a point-of-sale (POS) terminal configured to acquire tag information from wireless tags attached to items and perform checkout processing on the items using the acquired tag information; and
acquiring tag information from the POS terminal, and upon determining that the first tag information is not in the tag information acquired by the tag reader within the predetermined time period, outputting an alert indicating an item associated with the first tag information.

16. The non-transitory computer readable storage medium according to claim 15, wherein the method comprises:
connecting to a camera configured to capture images of the shelf and the items displayed on the shelf;
acquiring the images captured by the camera; and
upon determining that the first tag information has not been acquired by the tag reader within the predetermined time period, identifying an image captured before and an image captured after a time point at which the first tag information was most recently received by the tag reader.

17. The non-transitory computer readable storage medium according to claim 16, wherein the method comprises:
storing in the memory the images captured before and after the time point association with the item corresponding to the first tag information.

18. The non-transitory computer readable storage medium according to claim 16, wherein the method comprises:
connecting to a data storage apparatus to acquire the images captured by the camera.

19. The non-transitory computer readable storage medium according to claim 15, wherein
the alert indicates that the item associated with the first tag information is likely being stolen, and
the alert is output to a mobile terminal.

20. The non-transitory computer readable storage medium according to claim 15, wherein
the tag information in each wireless tag is a code that identifies a type of commodity and the individual item with which the wireless tag associated.
